(19) United States
(12) Patent Application Publication
(10) Pub. No.: US 2026/0027840 A1
(43) Pub. Date: Jan. 29, 2026

(54) PRINTING APPARATUS FOR PRINTING DIRECTLY ONTO CONTAINERS

(71) Applicant: Norwalt Design, Inc., Randolph, NJ (US)

(72) Inventor: Michael Seitel, Randolph, NJ (US)

(21) Appl. No.: 19/347,050

(22) Filed: Oct. 1, 2025

Related U.S. Application Data
(63) Continuation-in-part of application No. 19/218,759, filed on May 27, 2025.
Application No. 19/218,759 is a continuation of application No. 17/690,153, filed on Mar. 9, 2022, now Pat. No. 12,337,607.
Application No. 17/690,153 is a continuation-in-part of application No. 16/839,181, filed on Apr. 3, 2020, now abandoned.

(51) Int. Cl. B41J 3/407; B41J 2/01; B41M 5/00

(52) U.S. Cl. CPC B41J 3/40733; B41J 2/01; B41M 5/0088

(57) ABSTRACT

An apparatus for printing on a plurality of containers includes a plurality of print heads configured to print directly on a curved surface of each of the plurality of containers. At least one of the print heads is configured to rotate about at least one of the containers. A plurality of container holders is included for retaining the plurality of containers, each of the plurality of container holders configured to move a container linearly towards and linearly away from a print head in a continuous motion to maintain a print location on the curved surface of the container during a printing process while the print head rotates about the container. The plurality of containers are configured to move in a continuous printing direction different from the linearly towards and linearly away moving directions generally traverse to the plurality of print heads.

### CROSS REFERENCE TO RELATED APPLICATIONS

This application is a continuation-in-part of U.S. patent application Ser. No. 19/218,759, filed May 27, 2025, which is a continuation of U.S. patent application Ser. No. 17/690,153, filed Mar. 9, 2022, now U.S. Pat. No. 12,337,607, granted Jun. 24, 2025, which is a continuation-in-part of U.S. patent application Ser. No. 16/839,181, filed Apr. 3, 2020, abandoned, the contents of all of which are incorporated herein by reference in their entirety.

### FIELD OF THE INVENTION

The present invention relates to printing apparatuses, and more particularly, to printing apparatuses configured to print directly onto a container.

### BACKGROUND

Currently, there are printing apparatuses for printing onto containers in the marketplace. However, these printing apparatuses are configured to perform conventional printing on mostly flat labels or flat faces of containers. Printing directly onto curved surfaces of a container is difficult in as much as the distance from the print head and the surfaces change over a curved surface. For example, conventional print heads only dispense the ink a few millimeters if they are vertically positioned. Thus, the print head needs to be as close as possible to the surface of the container to retain print quality, e.g., the clearness of images or texts. If a distance greater than a few millimeters exists between the print head and the printing surfaces, which is often the case along a curved surface, the printing process may be difficult, and the print quality may not be satisfactory.

Accordingly, there exists a need for printing apparatuses to address effective printing on curved surfaces such as rounder curved surfaces.

### SUMMARY

According to an embodiment or embodiments of the present invention, an apparatus and a method are provided for printing on a curved container surface.

An apparatus for printing on a plurality of containers may include:
a plurality of print heads configured to print directly on a curved surface of each of the plurality of containers, at least one of the print heads of the plurality of printheads configured to rotate about at least one of the plurality of containers; and
a plurality of container holders for retaining the plurality of containers, each of the plurality of container holders configured to move the at least one container linearly towards and linearly away from the at least one print head in a continuous motion to maintain a print location on the curved surface of the at least one of the plurality of containers at a substantially constant perpendicular distance from the at least one of the plurality of print heads during a printing process while the at least one print head rotates about the at least one container; and
where the plurality of containers are configured to move in a continuous printing direction different from the linearly towards and linearly away moving directions generally traverse to the plurality of print heads.

The curved surfaces of the container may be at a constant velocity during the printing process.

Each of the plurality of container holders may include a linear actuator for moving the container relative to the at least one print head. The linear actuator may provide for the linear movement of the container towards and away from the print head. The plurality of container holders may further include a rotary actuator configured for rotation the container. The rotary actuator and the linear actuator may provide for rotational movement of the container and movement of the container toward and away from the print head. The rotational and/or linear movements of the container may occur along with the horizontal and/or rotational movements of the print heads.

The curved surface of the container may be cylindrical or non-cylindrical.

The apparatus may further include a circular turret for rotating around a circumference thereof, where the circular turret includes the plurality of container holders mounted thereon. The apparatus may further include an infeed starwheel for moving containers onto the circular turret and a discharge starwheel for moving containers off the circular turret.

In an aspect of the present invention, a method for printing onto a plurality of containers may include:
providing a plurality of print heads configured to print directly on a curved surface of each of the plurality of containers;
rotating at least one of the print heads of the plurality of print heads about at least one of the plurality of containers;
providing a plurality of container holders for retaining the plurality of containers, each of the plurality of container holders having an actuator for moving the at least one container;
moving the at least one container linearly towards and linearly away from the at least one print head in a continuous motion to maintain a print location on the curved surface of the at least one of the plurality of containers at a substantially constant perpendicular distance from the at least one of the plurality of print heads;
printing onto to the at least one container while the at least one print head rotates about the at least one container; and
moving the plurality of containers in a continuous printing direction different from the linearly towards and linearly away moving directions generally traverse to the plurality of print heads.

The method may further include maintaining the curved surface of the container at a substantially constant perpendicular distance from a nozzle or nozzles of the print head. The method may further include rotating the at least one container during the printing process.

These and other aspects of the present invention will be better understood in view of the drawings and following detailed description.

### BRIEF DESCRIPTION OF THE DRAWINGS

FIG. 1 is a top view of a printing apparatus, according to an embodiment of the present invention.

FIG. 2 is a side view of a container holder of the printing apparatus in FIG. 1.

FIGS. 3A-3E are top views of a container and a print head of the printing apparatus in FIG. 1, as the container continuously moves and rotates during a printing process.

FIG. 4 is a top view of a printing apparatus in accordance with a further embodiment of the present invention.

FIG. 5 is a side view of the container holder of the printing apparatus of FIG. 4.

FIG. 6 is a schematic depiction of movement of the container about the turret during the printing process.

FIG. 7 is a schematic depiction of movement of a cylindrical container about the turret during a printing process and of rotating movement of a printhead about the cylindrical container.

FIG. 8 is a schematic depiction of movement of a non-cylindrical container about the turret during a printing process and of rotating movement of a printhead about the non-cylindrical container.

### DETAILED DESCRIPTION

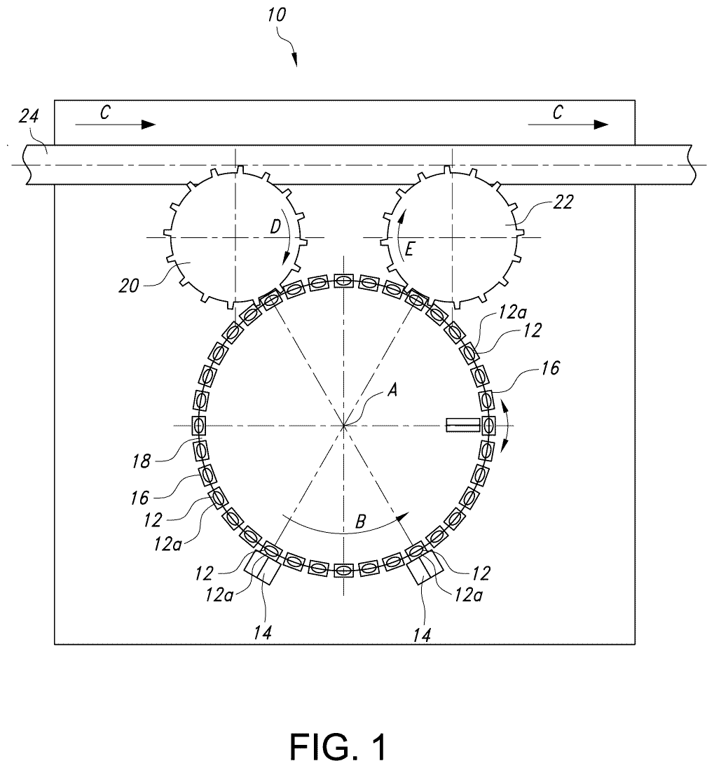

According to an embodiment of the present invention, referring to FIG. 1, there is shown a printing apparatus 10 configured to digitally print directly on the surfaces of a container 12 while the container 12 is in a continuous and constant motion. The printing apparatus 10 includes a plurality of print heads 14 for printing directly onto a curved surface 12a of the container 12 and a plurality of container holders 16 in a continuous automated operation. Each of the plurality of container holders 16 is configured to hold or retain the container 12 and is capable of providing both rotational movement and linear movement, as will be described in greater detail below. In the present illustrated embodiment, the containers 12 are shown as oval in general cross-section; but printing on containers having other non-flat cross-sectional shape is also contemplated.

Referring again to FIG. 1, the printing apparatus 10 further includes a printing wheel or turret 18 for rotating the containers 12 disposed within the plurality of container holders 16 about a turret vertical axis A, as will be described below, an infeed starwheel 20 is operable for transporting the containers 12 to the turret 18, and a discharge starwheel 22 is operable for transporting the containers 12 from the turret 18.

The circular turret 18 is configured to rotate in a counter-clockwise turret direction B about the turret vertical axis A with a constant speed. The turret 18 includes the plurality of container holders 16 mounted thereon for rotating the containers 12 to be printed. Each of the plurality of container holders 16 is disposed on the turret 18 with an evenly spaced distance therebetween.

A conveyor belt 24 moves in a longitudinal direction C and feeds the containers 12 to be printed to the infeed starwheel 20. The infeed starwheel 20 rotates in a clockwise infeed direction D, which is opposing to the rotational direction of the turret 18. Each of the containers 12 is transported to and retained in each corresponding container holder 16 via the infeed starwheel 20. Once the printing on the surface 12a of the container 12 is completed, the printed container 12 is transported from the container holder 16 via the discharge starwheel 22. The discharge starwheel 22 rotates in a clockwise discharge direction E, which is opposing to the rotational direction of the turret 18. After exiting from the container holder 16, the printed container 12 continuously moves on the conveyor belt 24 in the longitudinal direction C.

As noted above, the container 12 that may be used in connection with the present printing apparatus 10 has a shape with curved surfaces, e.g., oblong, oval, etc. Non-limiting examples of the container 12 to be printed include polyethylene terephthalate (PET) and high density polyethylene (HDPE), which may be made with monolayer or multilayer plastic materials.

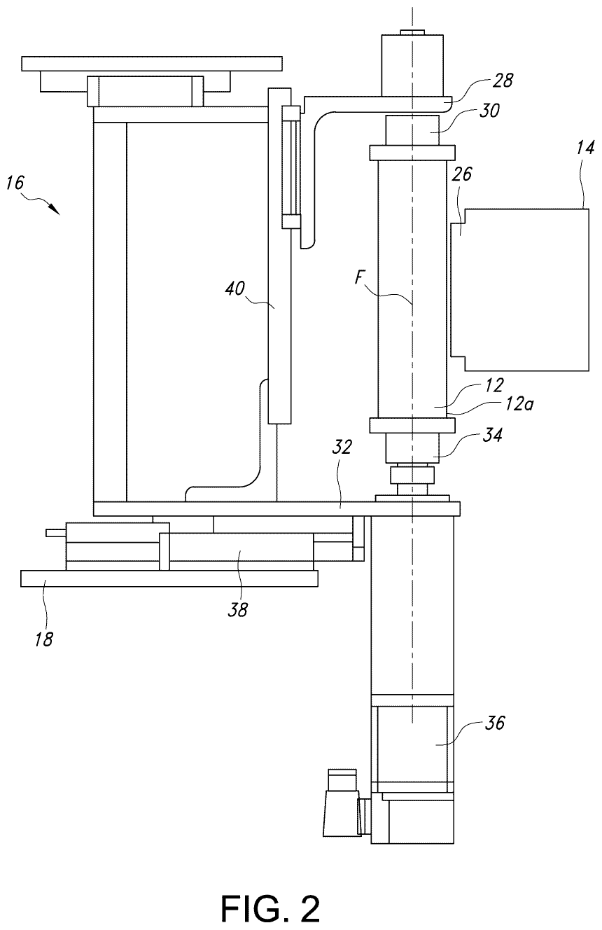

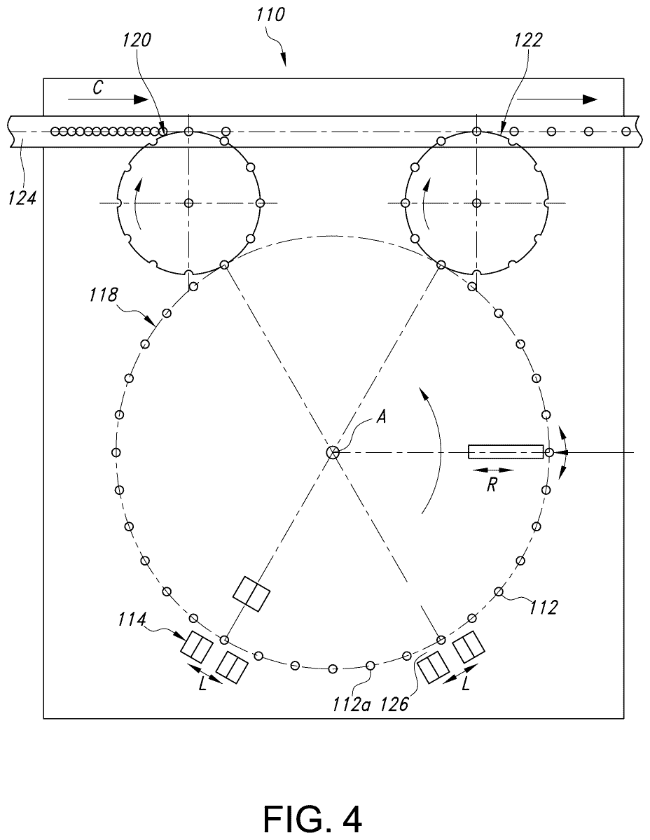

Referring to FIGS. 1 and 2, the plurality of print heads 14 are arranged outside of the turret 18 and in close proximity to the turret 18 such that a nozzle dispensing path is substantially tangent to a moving direction (e.g., counter-clockwise turret direction B) of the curved surfaces 12a of the container 12 to be printed. Each of the plurality of print heads 14 is an inkjet print head having one or more nozzles 26 for dispensing printing ink. The one or more nozzles 26 are positioned such that they are substantially parallel with a container vertical axis F. In the depicted embodiment, each of the plurality of print heads 14 has one nozzle. Additionally, it is contemplated that the print head 14 is capable of moving horizontally to allow the curved printing surfaces 12a of the container 12 to be at a constant velocity during the printing process. As will be described in further detail with respect to the embodiment of FIGS. 4-6, this is also advantageous in printing on round containers.

Referring particularly to FIG. 2, each of the plurality of container holders 16 is configured to provide both rotational movement and linear movement during the printing process as each container holder 16 moves continuously along the counter-clockwise turret direction D, as will be described in greater detail below.

Each of the plurality of container holders 16 includes an upper slide 28 having an upper mandrel 30 mounted thereon, a lower slide 32 having a lower mandrel 34 mounted thereon. A rotary actuator 36 and a linear actuator 38 are employed to move the container 12 with respect to the print head 14, as will be described in below. Non-limiting examples of the rotary actuator and linear actuator are server motor and stepper motor.

The container 12 is secured and retained within its corresponding container holder 16 by the upper mandrel 30 and the lower mandrel 34, while moving along the counter-clockwise turret direction D and while being printed by the plurality of print heads 14. Specifically, the upper mandrel 30 and lower mandrel 34 engage with a top end portion of the container 12 and a bottom end portion of the container 12, respectively, such that each end portion of the container 12 is mounted onto the upper mandrel 30 and lower mandrel 34. The upper mandrel 30 and lower mandrel 34 are located on the upper slide 28 and lower slide 30, respectively, at a length from the plurality of the print heads 14 such that a consistent distance is maintained from the printing surfaces 12a of the container 12 to the plurality of print heads 14 during the printing process, as the container 12 rotates about the container vertical axis F. The container vertical axis F is parallel to the turret vertical axis A.

In the depicted embodiment, the lower mandrel 34 of each of the plurality of container holders 12 is operably connected to the rotary actuator 36. The rotary actuator 36 is implemented under the lower slide 32 of the container holder 12, as shown in FIG. 2, and the rotary actuator 36 provides rotational movement about the container vertical axis F during the printing process. The rotational movement ensures that during the printing process, the printed location of the printing surface of the container 12 is maintained substantially perpendicular to the stationary print head 14 during the printing process. Alternately, the rotary actuator 36 may be operably connected to the upper mandrel 30 of each of the plurality of container holders 12.

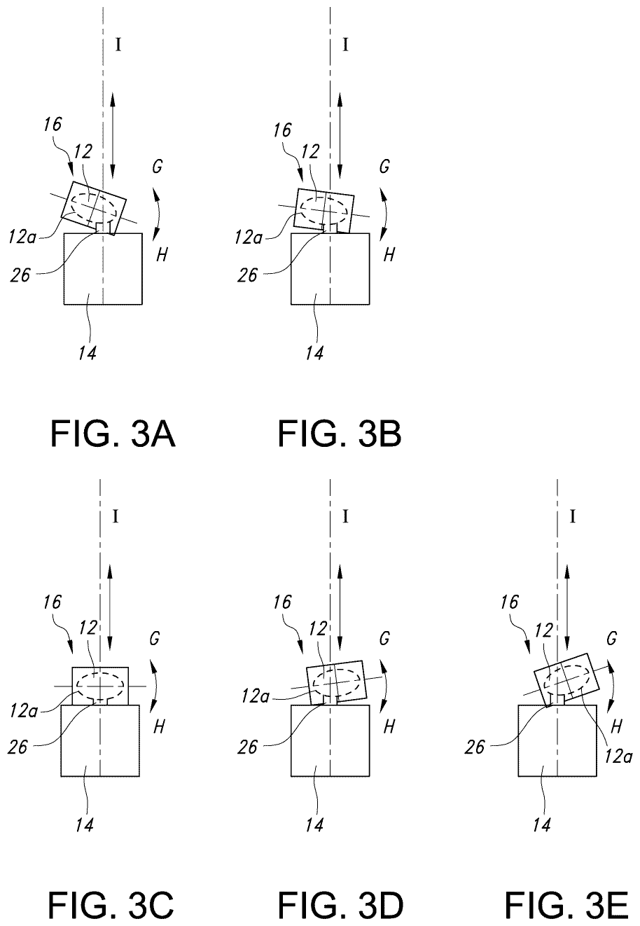

The rotary actuator 36 is configured such that it allows the container 12 to be rotated in either a counter-clockwise direction G or clockwise direction H with various desired degrees (e.g., up to 360 degrees). In the depicted embodiment, as shown in FIG. 3, the container 12 rotates about the container vertical axis F in the counter-clockwise direction G.

The linear actuator 38 is included in each of the plurality of container holders 16 for providing linear movement (toward and away from the print head 14) of the container holder 16. The linear actuator 38 is integrally connected to the lower slide 32 (which is connected to the upper slide 28 via a connecting bar 40) and disposed between the lower slide 32 and a top surface of the turret 18, as shown in FIG. 2. During the printing process, as the turret 18 continuously rotates at a constant speed and as the container 12 rotates, the linear actuator 38 allows the container 12 to move towards and away from the print head 14 along a line I. The linear movement combined with rotational movement allows a consistent distance to be retained from the printing surface of the container 12 to the print head 14, as the container 12 rotates and moves continuously along the moving direction (e.g., counter-clockwise turret direction D).

Referring to FIGS. 3A-3E, the printing process on the printing surfaces of the container 12 will be described. In the depicted embodiment, each container holder 16 having the container 12 therewithin enters a printing area with one side of the printing surface initially contacting with the nozzle 26 of the printing head 14, as shown in FIG. 3A. Due to the curved printing surfaces 12a of the container 12, the printing apparatus 10, specifically the container holder 16, is configured to rotate about the container vertical axis F as the printing on the container 12 progresses. As the container 12 is rotated about the container vertical axis F in the counter-clockwise direction G at an angular speed with the turret 18 being continuously moving in the counter-clockwise turret direction D, the nozzle 26 of the print head 14 dispenses the ink jet and prints directly on the curved printing surfaces 12a of the container 12 until the entire printing surface is printed in a desired fashion, as shown in FIGS. 3B-3E. While the container 12 is being rotated during the printing process, the linear actuator 38 of the container holder 16 moves the container 12 towards and away from the nozzle 26 of the printing head 14 along the line I to maintain a consistent distance from the printing surfaces of the container 12 to the print head 14, allowing the printed materials on the curved surfaces to be in a good print quality (e.g., the clearness of images or texts).

The printing process is continuous until the entire desired printing surface 12a of the container 12 is printed by the printing head 14 in one continuous motion. The print head 14 completes the printing process as the other side of the printing surface of the container 12 is reached, as shown in FIG. 3E. During the printing process, the print head 14 may remain stationary or move horizontally with respect to the turret 18 as the container 12 rotates about the container vertical axis F and moves linearly towards and away from the print head 14 to maintain a substantially constant distance between the print head 14 and the location of printing on the curved surface. The rotational movement and linear movement of the container 12 ensure that the location of printing on the curved surfaces 12a of the container 12 remains generally perpendicular to the print head 14 as the container 12 rotates during the printing process.

Accordingly, the combination of the rotational movement of the turret 18, the rotational movement of container 12, and the linear movement of container 12 provides a printing technique that may be achieved rapidly and continuously, and vastly improves printing quality on curved printing surfaces of the container 12.

From the foregoing, it will be appreciated that a printing apparatus according to the present invention provides a printing technique for directly printing on a container and improving printing quality on the curved printing surfaces of the container.

Referring now to FIGS. 4-6, a further embodiment of the present invention is shown which is particularly advantageous in printing on round bottles.

The present embodiment is substantially similar to the embodiment described above. For simplicity, with respect to the present embodiment, similar reference numerals will be used to denote similar elements.

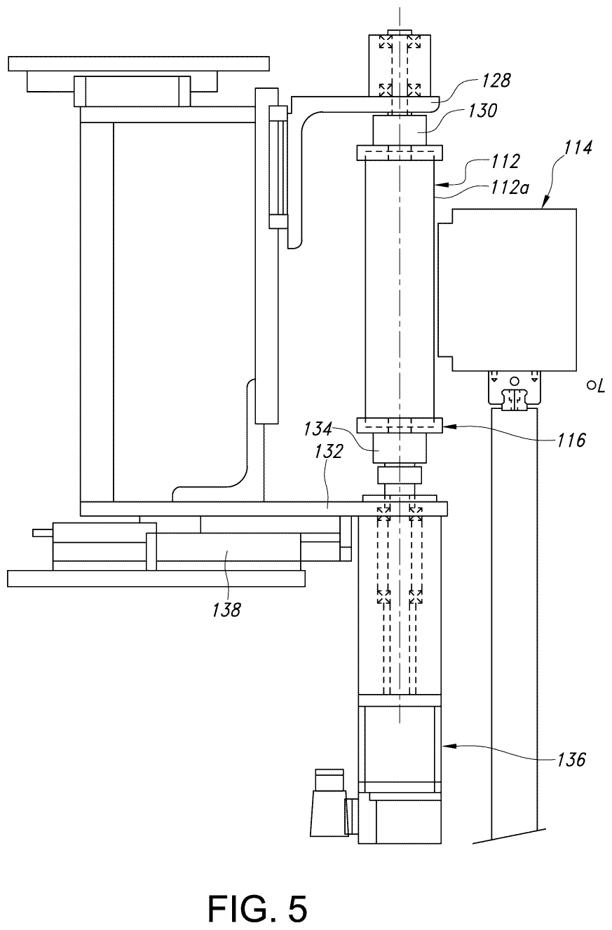

The printing apparatus 110 of the present embodiment includes a plurality of print heads 114 for printing directly onto a curved surface 112a of a container 112 held on a plurality of container holders 116 (FIG. 5) in a continuous automated operation. Each of the container holders 116 is configured to hold and retain a container 112 and is capable of providing both rotational movement and linear movement similar to that described above.

In the present illustrative embodiment, containers 112 are shown to be round containers in cross section. However, the present embodiment is not limited thereto.

As with the above embodiment, the present embodiment of the printing apparatus 110 includes a wheel or turret 118 for rotating the containers 112 around an axis A in the direction of arrow B. An infeed star wheel 120 is operable for transporting the containers 112 to the turret 118 and a discharge star wheel 122 is operable for transporting the containers 112 from the turret 118. A conveyor belt 124 moves in a longitudinal direction C and feeds the containers 112 to be printed into the infield star wheel 120. The discharge star wheel 122 accepts the printed containers and after exiting from the container holder 116, the printed containers 112 continuously move on a conveyor belt 124 in the longitudinal direction C. The operation of the conveyor belt, turret and star wheels are substantially similar to that described above with respect to the previous embodiment.

Referring additionally to FIG. 5 specifically, each of the plurality of container holders 116 is configured to provide both rotational movement and linear movement during the printing process.

The construction and movement of the container holders 116 is substantially similar to that described above with respect to FIG. 2. Each container holder 116 includes an upper slide 128 with an upper mandrel 130 mounted thereto, a lower slide 132 having a lower mandrel 134 mounted thereto.

A rotary actuator 136 and a linear actuator 138 are employed to move the container 112 with respect to the print head 114 in a manner similar to that described above with respect to FIG. 2 during the printing process. As the turret 118 continuously rotates preferably, but not necessarily, at a constant speed and as container 112 rotates, the linear actuator 138 allows the container to move towards and away from the print head (arrow R in FIG. 4). The linear movement combined with the rotational movement allows a constant distance to be maintained between the printing surface of the container 112 and the print head 114 as the container rotates and moves continuously along the moving direction. While a rotary and linear actuator are described, the same movement may be accomplished via servo motor, stepper motor, cams, pneumatics, etc.

In addition, with respect to round bottles, it has been found that constant distance between the printing surface of container 112 and the print head may be further facilitated by arranging the print head 114 to be movable in a back and forth linear direction L as the container rotates about turret 118.

Different from the embodiment shown in FIG. 2, the embodiment of FIG. 5 mounts the print head 114 for longitudinal movement generally along the path of the container holder 116 about turret 118 as indicated by double headed arrows L in FIGS. 4-6. In FIG. 5 the movement is into and out of the page.

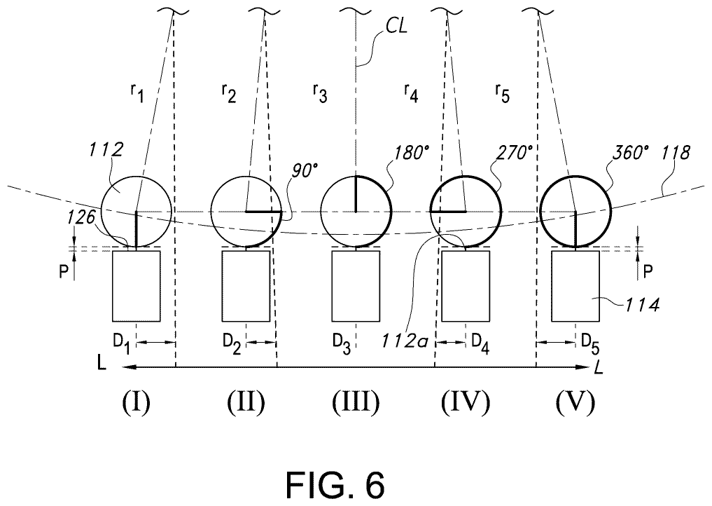

Referring specifically now to FIG. 6, the printing process for printing on surfaces 112a of round containers 112 may be described. While substantially similar to that described above with respect to FIGS. 3A-E, in this embodiment the printing process incorporates movement of the print head 114 along with movement of the container holder 116.

Each container 112 supported on the container holder 116 (not shown) enters a printing area so that one point of the surface 112a of container 112 is positioned adjacent nozzle 126 of printing head 114. A center line CL defines a neutral position for the print head along path L. As shown in FIG. 6, the print head is initially positioned at a location to the left at a distance of D₁ from the center line CL. At this position, the container 112 on the container holder 116 is positioned fully extended toward the circumference of the turret 118 defined as r₁ in FIG. 6. This defines position (I) where the nozzle 126 (not shown) is a distance P from container surface 112a. As the container 112 moves about the turret and is rotated counter-clockwise by the container holder 116, the print head 114 prints on the surface 112a of the container. The container 112 also retracts away from the circumference of the turret from its fully extended position r₁ to a position r₂ (which is less than r₁) defining position (II) where at that point the container 112 has been printed on 90° of the container surface 112a. The print head 114 moves along path L with the movement of container so as to maintain the constant distance P between the print head 114 and the container 112. When the container is retracted to r₂ the print head has moved to the right to a position which is a distance D₂ (less than D₁) from the center line CL.

As the container 112 continues to move about the turret 118, it is retracted further to a position r₃ which less than r₂ defined at position (III). Since the container 112 is continually rotating in a counter-clockwise direction, the container 112 will be printed on 180° of the container surface at position (III).

The print head will now be moved along path L to a distance D₃ which is at the center line CL so as to maintain the constant distance P.

The container 112 continues to move about the turret 118 from the position (III) to (IV) where, due to the counter-clockwise rotation, the container is now printed on 270° of the container. To maintain the constant distance P, the container is extended to r₄ which is equal to r₂. and the print head moves back to a position which is a distance D₄ from center line CL which is equal to distance D₂ but in the opposite direction.

Still further, the container moves along the turret to a position (V) where the container is extended to a radius r₅ which is equal to r₁. As the container continues its counter-clockwise revolution it is now printed on 360° of the container. Similarly, the print head has now moved a distance D₅ which is equal to distance D₁, but in the opposite direction so as to maintain the constant distance P between the print head and the container D.

While the present embodiment shows printing 360° about the container 112, it may be appreciated that printing may take place on less than the entire circumference of the container.

Thus, by movement of the container toward and away from the circumference of the turret while rotating the container and by movement of the print head a relatively constant distance is maintained between the print head and the container surface during printing.

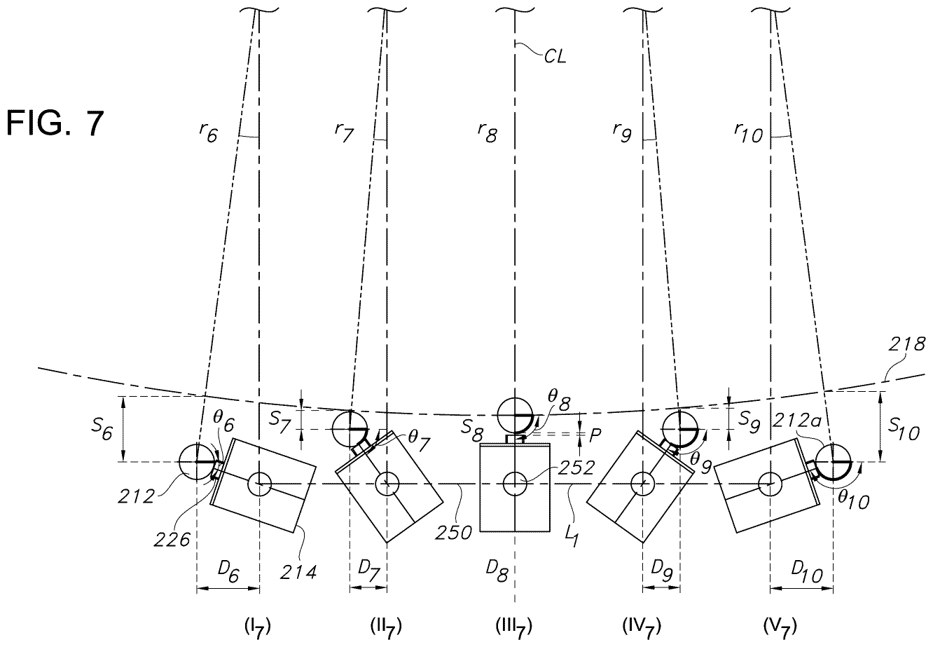

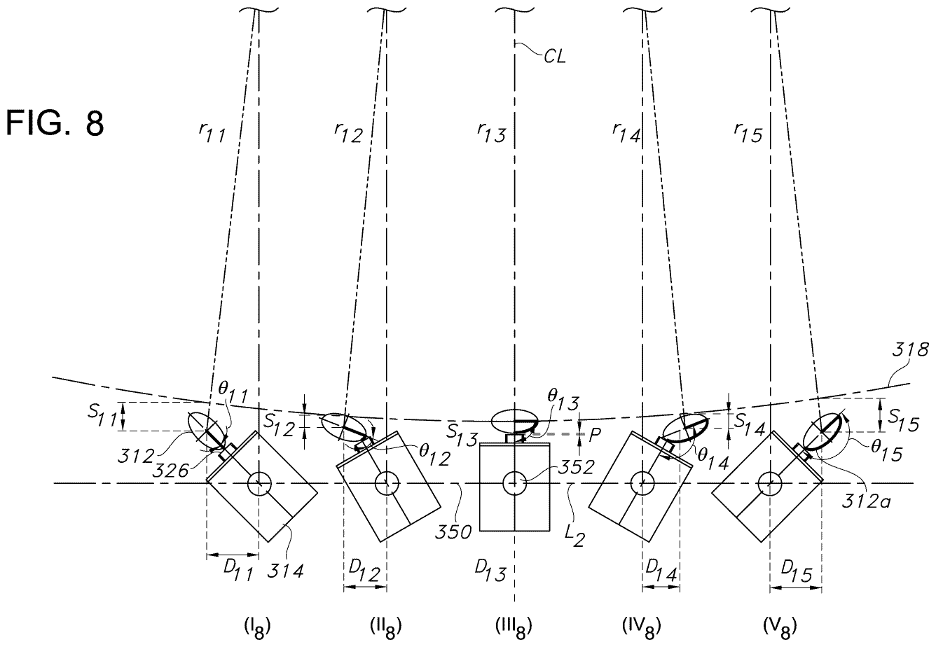

Referring now to FIGS. 7 and 8, a further embodiment of the present invention is shown which advantageously includes rotatable or pivotable printheads.

The further embodiment is substantially similar to the embodiments described above. For simplicity, with respect to the further embodiment, similar reference numerals will be used to denote similar elements.

Referring specifically now to FIG. 7, the printing process for printing on surfaces 212a of round or cylindrical containers 212 is described. While similar to that described above with respect to FIG. 6, in this embodiment the printing process incorporates rotating or pivoting movement of the print head 214 with respect to the container 212 along with radially inward and outward movement of the container 212 with respect to the turret holder 218.

Each container 212 supported on the container holder 216 (not shown) enters a printing area so that one point of the surface 212a of container 212 is positioned adjacent nozzle 226 of printing head 214. A center line CL defines a neutral position for the print head 214 along a path 250 or an axis L₁. Such a neutral position may be described as a position where a center-point or center-of-rotation of the turret 218 is parallelly aligned or substantially parallelly aligned with the print head 214 (see, e.g., printing position III₇).

As shown in FIG. 7, the container 212 is initially positioned at a location to the left at a distance of D₆ from the center line CL. The distance D₆ and the like may be considered as a tangential distance with respect to the turret 218 from the center line CL, such as a length of an opposite side of a right triangle with respect to angle r₆. At this position, the container 212 on the container holder 216 (not shown) is positioned and extended away from the center line CL as noted by angle r₆ in FIG. 7 and is also extended way from the circumference of the turret 218 defined as distance S₆ in FIG. 7. The distance S₆ and the like may be considered to a normal or perpendicular distance from the turret 218. This defines an initial printing position (I₇) where the nozzle 226 of the print head 214, which is a distance P from container surface 212a, is positioned for the commencement of printing onto the container 212. In this initial printing position print head 214 commences printing about the circumference of the container 212 and has an initial or minimal degree of rotation or pivoting about the container 212 as indicated by θ₆. Rotation of the print head 214 may be provided by an actuator (not shown) associated with the print head 214. As depicted in FIG. 7 a center-of-rotation 252 of the print head 214 may be aligned or substantially aligned with the center line CL.

As the container 212 moves with the turret 218 in a counter-clockwise direction, the print head 214 rotates in a clockwise direction about its center-of-rotation 252 and prints on the surface 212a of the container 212. The container 212 also retracts towards the circumference of the turret 218 from its fully extended position of III₇ as noted by angle r₆ to a position noted by angle r₇ (which is less than r₆) defining position (II₇) where at that point the container 212 has been printed on about θ₇ degrees of the container surface 212a which corresponds to clockwise rotation of the print head 214 about the container 212 by a degree of rotation of θ₇, where θ₇>θ₆. The container 212 is positioned closer to the turret 218 as indicated by distance S₇, where S₇<S₆. The print head 214 also moves along path L₁ with the movement of container 212 while also rotating about the container 212 so as to maintain the constant distance P between the print head 214 and the container 212. The center-of-rotation 252 of the print head 214 may remain substantially in line with the center line CL. When the container is retracted to angle r₇ the container 212 print head 214 has moved to the right to a position which is a distance D₇ from the center line CL, where D₇<D₆.

As the container 212 continues to move about the turret 218, it is retracted further to a position as indicated by angle r₈, where r₈<r₇<r₆, which defines the position III₇. At this position III₇ there is little or minimal distance or extension of the container 212 from the turret 218 as indicated by Ss and little or minimal offset of the container 212 from the center line CL as indicated by D₈. The print head 214 has rotated θ₈ degrees which may correspond to printing θ₈ degrees along the circumference of the container 212 at position III₇.

The container 212 continues to move about the turret 218 from the position III₇ to position IV₇ where, due to the clockwise rotation of the print head 214 by θ₉ degrees, the container 212 is now printed on θ₉ degrees of the container. To maintain the constant distance P, the container 212 is extended to an angle r₉ from the center line CL, which may be equal to r₇, and the container 212 moves back to a position which is a distance D₉ from center line CL which may be the same as distance D₇ but in the opposite direction. The container 212 is further moved away from the turret 218 as indicated by distance S₉, which may correspond to distance S₇.

Still further, the container 212 moves along the turret 218 to a position V₇ where the container 212 is extended to a radius r₁₀ which may be equal to r₆. As the print head 214 continues its clockwise revolution it has now rotated θ₁₀ degrees may correspond to printing over θ₁₀ degrees pf the surface of the container 212. Similarly, the container 212 has moved a distance D₁₀ from the center line, which may be equal to distance D₆, and has moved a distance S₁₀ from the turret 218, which may be equal to D₆. A constant distance P between the print head 214 and the container 212 is maintained during the printing process. Also during the printing process, the center-of-rotation 252 of the print head 214 may remain, if desired, substantially aligned with the center line CL and the axis L₁ as shown.

While the present embodiment shows printing along a portion of the circumference of the container 212, it may be appreciated that printing may take place on the entire circumference of the container including, if desired multiple passes along the circumference of the container. For example, the container 212 may rotate in a counter-clockwise direction as controlled by the container holder and as described above while the print head 214 is rotating and printing in a clockwise direction about the container 212. Further, the container holder 216 (not shown) may also provide vertical movement of the container 212. Still further, the center-of-rotation 252 of the print head 214 need not remain substantially aligned with the center line CL and the axis L₁ as shown. For example, actuators (not shown) associated with the print heads may not only provide for rotational movement of the print heads but may also provide linear, including vertical, horizontal, and angled movement, of the print heads.

While the containers 212 in FIG. 7 are shown to be round containers in cross section, the present invention is not so limited thereto. One embodiment of the present invention for non-round containers in cross section, such as oval containers, is described below in conjunction with FIG. 8.

Referring specifically now to FIG. 8, the printing process for printing on surfaces 312a of non-round or non-cylindrical containers such as oval container 312 is described. In this embodiment the printing process also incorporates rotating or pivoting movement of the print head 314 with respect to the container 312 along with radially inward and outward movement of the container 312 with respect to the turret holder 318.

Each container 312 supported on the container holder 316 (not shown) enters a printing area so that one point of the surface 312a of container 312 is positioned adjacent nozzle 326 of printing head 314. A center line CL defines a neutral position for the print head 314 along a path 350 or an axis L₂. Such a neutral position may be described as a position where a center-point or center-of-rotation of the turret 318 is parallelly aligned or substantially parallelly aligned with the print head 314 (see, e.g., printing position III₈).

As shown in FIG. 8, the container 312 is initially positioned at a location to the left at a distance of D₁₁ from the center line CL. The distance D₁₁ and the like may be considered as a tangential distance with respect to the turret 318 from the center line CL, such as a length of an opposite side of a right triangle with respect to angle r₁₁. At this position, the container 312 on the container holder 316 (not shown) is positioned and extended away from the center line CL as noted by angle r₁₁ in FIG. 8 and is also extended way from the circumference of the turret 318 defined as distance S₁₁ in FIG. 8. The distance S₁₁ and the like may be considered to a normal or perpendicular distance from the turret 318. This defines an initial printing position (I₈) where the nozzle 326 of the print head 314, which is a distance P from container surface 312a, is positioned for the commencement of printing onto the container 312. In this initial printing position print head 314 commences printing about the circumference of the container 312 and has an initial or minimal degree of rotation or pivoting about the container 312 as indicated by θ₁₁. Rotation of the print head 314 may be provided by an actuator (not shown) associated with the print head 314. As depicted in FIG. 8 a center-of-rotation 352 of the print head 314 may be aligned or substantially aligned with the center line CL.

As the container 312 moves with the turret 318 in a counter-clockwise direction, the print head 314 rotates in a clockwise direction about its center-of-rotation 352 and prints on the surface 312a of the container 312. The container 312 also retracts towards the circumference of the turret 318 from its fully extended position of III₈ as noted by angle r₁₁ to a position noted by angle r₁₂ (which is less than r₁₂) defining position (II₈) where at that point the container 312 has been printed on about θ₁₂ degrees of the container surface 312a which corresponds to clockwise rotation of the print head 314 about the container 312 by a degree of rotation of θ₁₂, where θ₁₂>θ₁₁. The container 312 is positioned closer to the turret 318 as indicated by distance S₁₂, where S₁₂<S₁₁. The print head 314 also moves along path L₂ with the movement of container 312 while also rotating about the container 312 so as to maintain the constant distance P between the print head 314 and the container 312. The center-of-rotation 352 of the print head 314 may remain substantially in line with the center line CL. When the container 314 is retracted to angle r₁₂ the container 312 and the print head 314 have moved to the right to a position which is a distance D₁₂ from the center line CL, where D₁₂<D₁₁.

As the container 312 continues to move about the turret 318, it is retracted further to a position as indicated by angle r₁₂, where r₁₃<r₁₂<r₁, which defines the position III₈. At this position III₈ there is little or minimal distance or extension of the container 312 from the turret 318 as indicated by S₁₃ and little or minimal offset of the container 312 from the center line CL as indicated by D₁₃. The print head 314 has rotated θ₁₃ degrees which may correspond to printing θ₁₃ degrees along the circumference of the container 312 at position III₈.

The container 312 continues to move about the turret 318 from the position III₈ to position IV₈ where, due to the clockwise rotation of the print head 314 by θ₁₄ degrees, the container 312 is now printed on θ₁₄ degrees of the container. To maintain the constant distance P, the container 312 is extended to an angle r₁₄ from the center line CL, which may be equal to r₁₂, and the container 312 moves back to a position which is a distance D₁₄ from center line CL which may be the same as distance D₁₂ but in the opposite direction. The container 312 is further moved away from the turret 318 as indicated by distance S₁₄, which may correspond to distance S₁₂.

Still further, the container 312 moves along the turret 318 to a position V₈ where the container 312 is extended to a radius r₁₅ which may be equal to r₁₁. As the print head 314 continues its clockwise revolution it has now rotated θ₁₅ degrees may correspond to printing over θ₁₅ degrees pf the surface of the container 312. Similarly, the container 312 has moved a distance D₁₅ from the center line, which may be equal to distance D₁₁, and has moved a distance S₁₅ from the turret 318, which may be equal to D₁₁. A constant distance P between the print head 314 and the container 312 is maintained during the printing process. Also during the printing process, the center-of-rotation 352 of the printhead 314 may remain, if desired, substantially aligned with the center line CL and the axis L₂ as shown.

While the present embodiment shows printing along a portion of the circumference of the container 312, it may be appreciated that printing may take place on the entire circumference of the container including, if desired multiple passes along the circumference of the container. For example, the container 312 may rotate in a counter-clockwise direction as controlled by the container holder and as described above while the print head 314 is rotating and printing in a clockwise direction about the container 312. Further, the container holder 316 (not shown) may also provide vertical movement of the container 312. Still further, the center-of-rotation 352 of the printhead 314 need not remain substantially aligned with the center line CL and the axis L₂ as shown. For example, actuators (not shown) associated with the print heads may not only provide for rotational movement of the print heads but may also provide linear, including vertical, horizontal, and angled movement, of the print heads.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and of the claims appended hereto. Further, description of rotations of the various elements in clockwise and counter-clockwise are not limiting and may be considered to generally describe opposite directions of movement.

What is claimed is:

1. An apparatus for printing on a plurality of containers, the apparatus comprising:
a plurality of print heads configured to print directly on a curved surface of each of the plurality of containers, at least one of the print heads of the plurality of printheads configured to rotate about at least one of the plurality of containers; and
a plurality of container holders for retaining the plurality of containers, each of the plurality of container holders configured to move the at least one container linearly towards and linearly away from the at least one print head in a continuous motion to maintain a print location on the curved surface of the at least one of the plurality of containers at a substantially constant perpendicular distance from the at least one of the plurality of print heads during a printing process while the at least one print head rotates about the at least one container;
wherein the plurality of containers are configured to move in a continuous printing direction different from the linearly towards and linearly away moving directions generally traverse to the plurality of print heads.

2. The apparatus of claim 1, wherein the curved surfaces of the container are at a constant velocity during the printing process.

3. The apparatus of claim 1, each of the plurality of container holders includes a linear actuator for moving the container relative to the at least one print head.

4. The apparatus of claim 3, wherein the linear actuator provides for the linear movement of the container towards and away from the print head.

5. The apparatus of claim 4, the plurality of container holders further comprise a rotary actuator configured for rotation the container.

6. The apparatus of claim 5, wherein the rotary actuator and the linear actuator provide for rotational movement of the container and movement of the container towards and away from the print head.

7. The apparatus of claim 5, wherein the rotational and linear movement of the container occurs along with the horizontal movement of the print heads.

8. The apparatus of claim 1, wherein the curved surface is cylindrical.

9. The apparatus of claim 1, wherein the curved surface is non-cylindrical.

10. The apparatus of claim 1, further comprising:
a circular turret for rotating around a circumference thereof;
wherein the circular turret comprises the plurality of container holders mounted thereon.

11. The apparatus of claim 10, further including an infeed starwheel for moving containers onto the circular turret and a discharge starwheel for moving containers off the circular turret.

12. A method for printing onto a plurality of containers, comprising:
providing a plurality of print heads configured to print directly on a curved surface of each of the plurality of containers;
rotating at least one of the print heads of the plurality of print heads about at least one of the plurality of containers;
providing a plurality of container holders for retaining the plurality of containers, each of the plurality of container holders having an actuator for moving the at least one container;
moving the at least one container linearly towards and linearly away from the at least one print head in a continuous motion to maintain a print location on the curved surface of the at least one of the plurality of containers at a substantially constant perpendicular distance from the at least one of the plurality of print heads;
printing onto to the at least one container while the print head rotates about the at least one container; and
moving the plurality of containers in a continuous printing direction different from the linearly towards and linearly away moving directions generally traverse to the plurality of print heads.

13. The method of claim 12, further comprising:
rotating the at least one container during the printing process.
